(19) United States
(12) Patent Application Publication
(10) Pub. No.: US 2018/0285268 A1
(43) Pub. Date: Oct. 4, 2018

(54) METHOD AND APPARATUS FOR REDUCING WRITE CONGESTION IN NON-VOLATILE MEMORY BASED LAST LEVEL CACHES

(71) Applicant: Intel Corporation, Santa Clara, CA (US)

(72) Inventors: Kunal Kishore Korgaonkar, Bastora (IN); Ishwar S. Bhati, Bangalore (IN); Huichu Liu, San Jose, CA (US); Jayesh Gaur, Bangalore (IN); Sasikanth Manipatruni, Portland, OR (US); Sreenivas Subramoney, Bangalore (IN); Tanay Karnik, Portland, OR (US); Hong Wang, Santa Clara, CA (US); Ian A. Young, Portland, OR (US)

(73) Assignee: Intel Corporation, Santa Clara, CA (US)

(21) Appl. No.: 15/475,197

(22) Filed: Mar. 31, 2017

(51) Int. Cl. G06F 12/0811; G06F 12/0808; G06F 12/1045; G06F 13/40

(52) U.S. Cl. CPC G06F 12/0811; G06F 12/0808; G06F 12/1054; G06F 13/4027; G06F 2212/684; G06F 2212/1021; G06F 2212/60; G06F 2212/62; G06F 2212/1024

(57) ABSTRACT

In one embodiment, a processor comprises a processing core, a last level cache (LLC), and a mid-level cache. The mid-level cache is to determine that an idle indicator has been set, wherein the idle indicator is set based on an amount of activity at the LLC, and based on the determination that the idle indicator has been set, identify a first cache line to be evicted from a first set of cache lines of the mid-level cache and send a request to write the first cache line to the LLC.

### FIELD

The present disclosure relates in general to the field of computer development, and more specifically, to cache memory.

### BACKGROUND

With the ever-increasing memory footprints of current and future applications, larger caches provide substantial performance gains in each processor generation. Due to high power leakage and area, the size of static random access memory (SRAM)-based last level cache (LLC) may be limited. Recent non-volatile memory (NVM) technologies, such as Spin Hall Effect Magnetic RAM (SHE-MRAM), Spin Transfer Torque Magnetic RAM (STTRAM), Phase Change Memory (PCM), and Resistive Random Access Memory (ReRAM) as examples, have emerged as promising alternatives for SRAM-LLC. These memories have significant capacity and power advantages as compared to SRAM, e.g., STTRAM is shown to have ten times lower power leakage and four times lower area consumption compared to SRAM. However, an NVM-LLC may have higher write latency than write latency of an SRAM-LLC. In an NVM-LLC, read requests often wait in queues for high-latency write operations to finish, resulting in performance loss, even with higher-capacity NVM-LLCs.

### BRIEF DESCRIPTION OF THE DRAWINGS

FIG. 1 is a block diagram of an integrated circuit with an NVM-LLC in accordance with certain embodiments.

FIG. 2 illustrates example communications involving an L2 cache and an inclusive NVM-LLC in accordance with certain embodiments.

FIG. 3 illustrates example communications involving an L2 cache and an exclusive NVM-LLC in accordance with certain embodiments.

FIG. 4 illustrates an example L2 scrubber in communication with an NVM-LLC and an L2 cache in accordance with certain embodiments.

FIG. 5 illustrates an example flow for performing an eager write to an NVM-LLC in accordance with certain embodiments.

FIG. 6 illustrates an example flow for implementing optimized relaxed exclusivity at an NVM-LLC in accordance with certain embodiments.

FIG. 7 illustrates an example flow for implementing optimized relaxed exclusivity at an L2 cache in accordance with certain embodiments.

FIG. 8 illustrates an example flow for reducing writes caused by frequently dirty cache lines in accordance with certain embodiments.

FIG. 9A is a block diagram illustrating both an exemplary in-order pipeline and an exemplary register renaming, out-of-order issue/execution pipeline in accordance with certain embodiments.

FIG. 9B is a block diagram illustrating both an exemplary embodiment of an in-order architecture core and an exemplary register renaming, out-of-order issue/execution architecture core to be included in a processor in accordance with certain embodiments.

FIGS. 10A-B illustrate a block diagram of a more specific exemplary in-order core architecture, which core would be one of several logic blocks (potentially including other cores of the same type and/or different types) in a chip in accordance with certain embodiments.

FIG. 11 is a block diagram of a processor that may have more than one core, may have an integrated memory controller, and may have integrated graphics in accordance with certain embodiments.

FIGS. 12, 13, 14, and 15 are block diagrams of exemplary computer architectures in accordance with certain embodiments.

FIG. 16 is a block diagram contrasting the use of a software instruction converter to convert binary instructions in a source instruction set to binary instructions in a target instruction set in accordance with certain embodiments.

Like reference numbers and designations in the various drawings indicate like elements.

### DETAILED DESCRIPTION

Although the drawings depict particular computer systems, the concepts of various embodiments are applicable to any suitable integrated circuits and other logic devices. Examples of devices in which teachings of the present disclosure may be used include desktop computer systems, server computer systems, storage systems, handheld devices, tablets, other thin notebooks, systems on a chip (SOC) devices, and embedded applications. Some examples of handheld devices include cellular phones, digital cameras, media players, personal digital assistants (PDAs), and handheld PCs. Embedded applications may include a microcontroller, a digital signal processor (DSP), a system on a chip, network computers (NetPC), set-top boxes, network hubs, wide area network (WAN) switches, or any other system that can perform the functions and operations taught below. Various embodiments of the present disclosure may be used in any suitable computing environment, such as a personal computing device, a server, a mainframe, a cloud computing service provider infrastructure, a datacenter, a communications service provider infrastructure (e.g., one or more portions of an Evolved Packet Core), or other environment comprising a group of computing devices.

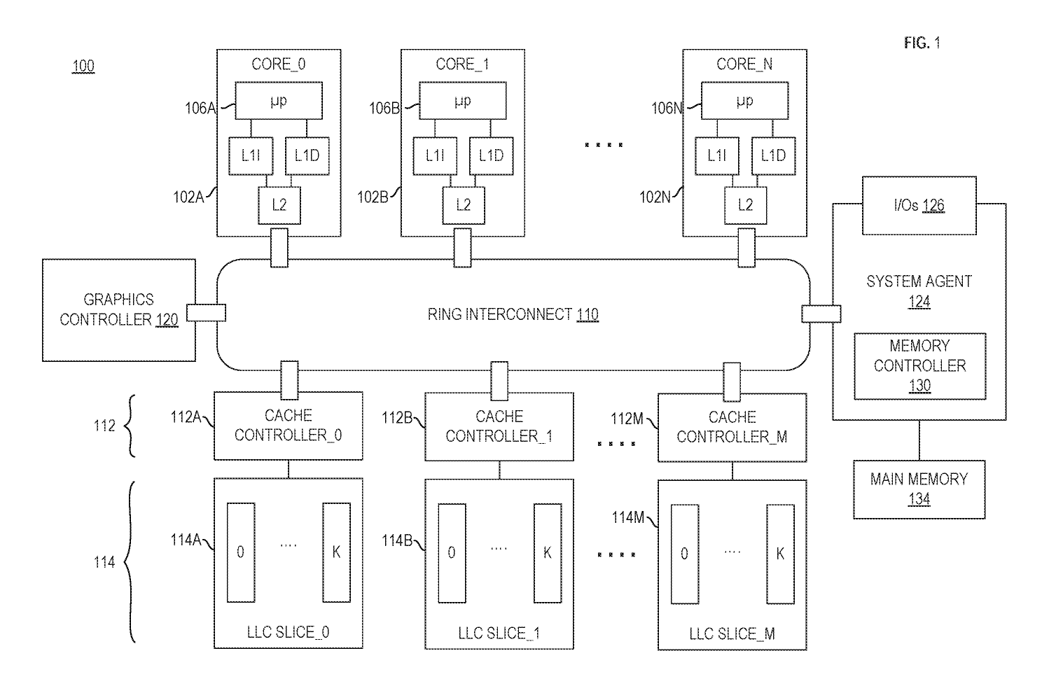

FIG. 1 is a block diagram of an integrated circuit 100 with an NVM-LLC 114 in accordance with certain embodiments. The integrated circuit 100 may be a processor or a system on a chip in various embodiments. The integrated circuit 100 may include, for example, one or more cores 102A, 102B . . . 102N. The cores may include a corresponding microprocessor 106A, 106B, or 106N, level one instruction (L1I) cache, level one data cache (L1D), and level two (L2) cache. The integrated circuit 100 may further include one or more cache controllers 112A, 112B . . . 112M (collectively referred to as cache controller 112), and corresponding LLC slices 114A, 114B . . . 114M (collectively referred to as LLC 114). An LLC may be made up of any suitable number of one or more LLC slices. Each LLC slice may include one or more banks of non-volatile memory. The integrated circuit 100 may further include a ring interconnect 110 or other bus through which the various components of the integrated circuit 100 connect. In one embodiment, the integrated circuit 100 further includes a graphics controller 120 and a system agent 124. The system agent 124 may, through the ring interconnect 110, act on behalf of various input-output devices (IOs) 126 and a memory controller 130. Memory controller 130 manages memory transactions to and from a main memory 134.

The integrated circuit 100 may be any type of processor, including a general purpose microprocessor, special purpose processor, microcontroller, coprocessor, a graphics processor, accelerator, field programmable gate array (FPGA), or other type of processor (e.g., any processor described herein). The integrated circuit 100 may include multiple threads and multiple execution cores, in any combination. In one embodiment, the integrated circuit 100 is integrated in a single integrated circuit die having multiple hardware functional units (hereafter referred to as a multi-core system). The multi-core system may be a multi-core processor package, but may include other types of functional units in addition to processor cores. Functional hardware units may include processor cores, digital signal processors (DSP), image signal processors (ISP), graphics cores (also referred to as graphics units), voltage regulator (VR) phases, input/output (I/O) interfaces (e.g., serial links, DDR memory channels) and associated controllers, network controllers, fabric controllers, or any combination thereof.

I/O devices 126 may include any I/O device or subcomponent thereof, such as a driver belonging to an I/O device, or software program capable of accessing (e.g., reading from, writing to) the main memory 134. When an I/O device 126 is a driver, the driver may be running on the cores 102a, 102b . . . 102n even though the driver belongs to an I/O device. An example of an I/O device may include a graphics device or graphics driver. An I/O device may receive or be assigned a memory address, multiple memory addresses, a block of memory addresses, or multiple blocks of memory addresses (hereafter referred to collectively as “an address”). For example, an operating system executed by the cores may assign the I/O device an address to use during operation. Alternatively, the I/O device may arbitrarily select an address from a list of available memory addresses. In some embodiments, the I/O device may be integrated with the integrated circuit 100 as part of an SoC.

The LLC 114 may include any type of non-volatile memory. Non-volatile memory is a storage medium that does not require power to maintain the state of data stored by the medium. Nonlimiting examples of nonvolatile memory may include any or a combination of: solid state memory (such as planar or 3D NAND flash memory or NOR flash memory), 3D crosspoint memory, byte addressable nonvolatile memory devices, ferroelectric memory, silicon-oxide-nitride-oxide-silicon (SONOS) memory, polymer memory (e.g., ferroelectric polymer memory), ferroelectric transistor random access memory (Fe-TRAM) ovonic memory, nanowire memory, electrically erasable programmable read-only memory (EEPROM), a memristor, phase change memory (e.g., PCS, PCM, PCME, PCRAM, Ovonic Unified Memory, Chalcogenide RAM, C-RAM, etc.), Spin Hall Effect Magnetic RAM (SHE-MRAM), Spin Transfer Torque Magnetic RAM (STTRAM), or other NVM memory devices. In some embodiments, 3D crosspoint memory may comprise a transistor-less stackable cross point architecture in which memory cells sit at the intersection of words lines and bit lines and are individually addressable and in which bit storage is based on a change in bulk resistance. In various embodiments, STTRAM may utilize a magnetic tunnel junction (MTJ), which is composed of a thin insulator layer sandwiched between a fixed ferromagnetic layer (polarization reference layer) and a free layer, to store the spin orientations as memory states (logic 0 or 1). The control of the MTJ states is through an access transistor, where the current flow through the MTJ can generate a spin torque based on the current direction and switch the magnetization direction in the free layer. The parallel and antiparallel magnetization states of the free layer (with respective to the reference layer) result in low resistance and high resistance states of the MTJ.

In various embodiments, the main memory 134 may also include non-volatile memory. The main memory 134 stores instructions and/or data that are to be interpreted and/or executed by the cores 102A, 102B . . . 102N. The cores may be coupled towards the main memory 134 via the ring interconnect 110. In some embodiments, the main memory 134 is a dual-inline memory module (DIMM) or has another suitable form factor. In various embodiments, the main memory 134 may also include volatile memory, such as in the form of random access memory (RAM) or registers.

Integrated circuit 100 is shown as having a multi-level cache architecture. In one embodiment, the cache architecture includes an on-die or on-package L1 and L2 cache and off-chip NVM-LLC 114. In another embodiment, the LLC 114 may also be on-die or on-chip, and may be shared amongst the cores 106a, 106b, . . . 106n, where requests from the cores are routed through the ring interconnect 110 based on request address. Any number of cache configurations and cache sizes are contemplated. Depending on the architecture, the cache may be a single internal cache located on an integrated circuit or may be multiple levels of internal caches on the integrated circuit. Other embodiments include a combination of both internal and external caches depending on particular embodiments.

In other embodiments, the cache architecture may include additional levels of cache, such as L3, L4, and so on. Any cache (e.g., an L2, L3, L4, or other cache) that is located between an L1 cache and an LLC may be referred to herein as a mid-level cache. Although this disclosure largely focuses on the interaction of an L2 cache with an LLC, the teachings surrounding the L2 cache may be applied to any mid-level cache. When a request misses in the L1 cache, the request may be sent to one or more mid-level caches. If the request misses in these caches, it may then be sent to the LLC 114.

In various embodiments, LLC 114 may include or otherwise be associated with a read queue storing pending read requests for the LLC and a write queue storing pending write requests for the LLC. In a particular embodiment, the queues may be combined into a unified queue (e.g., a request queue) that stores both types of requests. The queue(s) may be located, e.g., within a cache controller 112, or within one or more of the LLC slices 114a-m.

During operation, a core 102a, 102b . . . or 102n may send a memory request (read request or write request), via the L1 caches, to the L2 cache (and/or other mid-level cache positioned before the LLC). In one case, the memory controller 112 may intercept a read request from an L1 cache. If the read request hits the L2 cache, the L2 cache returns the data in the cache line that matches a tag lookup. If the read request misses the L2 cache, then the read request is forwarded to the LLC (or the next mid-level cache and eventually to the LLC if the read request misses the mid-level cache(s)). In another case, the cache controller 112 may intercept a write request from an L1 cache. If the write request hits the L2 cache after a tag lookup, then the cache controller 112 may perform an in-place write of the data in the cache line. If there is a miss, the cache controller 112 may create a read request to the LLC to bring in the data to the L2 cache. Both read request and write request misses may bring new cache lines into the L2 cache; accordingly, to make space for the new cache lines, the L2 cache may evict some existing cache lines using any suitable eviction policy.

Increasing the capacity of an LLC (such as LLC 114) can improve system performance, since a smaller LLC may result in a bottleneck to application performance. However, increasing the size of traditional SRAM-LLCs typically provides diminishing returns due to prohibitive area requirements and leakage power. Emerging NVM technologies provide high density and low leakage, thereby offering an attractive alternative for building large capacity LLCs. However, compared to SRAM, these technologies have significantly longer latency for write operations which may interfere with read operations, limiting the performance potential of NVM-LLCs. Additionally, the high write latency pressures the LLC request queues which creates backpressure on the core L1/L2 caches and can stall the core. These problems may limit the performance potential of some NVM-LLCs.

In various systems, the write latency of an NVM-LLC may be addressed by upsizing the write access transistors at the circuit level, or by using heavily banked LLC. However, such approaches result in higher overall power and lower density, thereby mitigating the advantages offered by NVM technologies. In various systems, write congestion may be partially alleviated by using a hybrid cache comprising a main portion of NVM-based memory and a smaller portion of SRAM-based memory. The SRAM may be allocated for cache lines that are frequently written to in order to reduce writes to the main NVM-based portion. An algorithm may predict the cache lines making frequent dirty trips and write them in the SRAM portion of the LLC while slow moving clean lines are either written directly to the main NVM-based portion of the LLC or migrated from the SRAM portion to the NVM portion. However, a hybrid cache requires the management of two different memory technologies. Moreover, as SRAM has lower density than NVM, such an approach results in lower overall capacity (when compared against a pure NVM-based LLC) and hence bounds the performance of capacity sensitive applications.

Various embodiments of the present disclosure dynamically observe congestion at the LLC 114 and mitigate the performance impact of writes by reducing the interference of writes with reads (e.g., by time shifting the writes) or by eliminating a fraction of writes at the LLC 114. In various embodiments, the interference caused by write operations to read operations is reduced by utilizing phases of low activity at the LLC to serve most of the writes. This may be accomplished by employing an intelligent scrubber at the L2 cache (referred to herein as “L2 scrubber”) that uses spare bandwidth at the LLC during periods of low activity to eagerly write to the LLC from the L2 cache (or other mid-level cache). In this manner, the LLC write traffic is smoothened out over time, thus reducing interference with latency-critical read requests.

Various embodiments may optimize a technique known as Relaxed Exclusivity (RE) (which may be used, e.g., with exclusive LLCs), in which writes in the LLC of cache lines making frequent clean trips are eliminated by selectively replicating lines between L2 and LLC. The replication cost may be reduced by invalidating RE cache lines when they become dirty and by setting low replacement ages (e.g., by not resetting the replacement ages upon a hit in the LLC) for such cache lines. In this manner, RE relieves write congestion and retains most of the performance improvements of the higher LLC capacity enabled by NVM. Thus, various embodiments may trade off a small amount of read hit rates in order to bypass a large fraction of writes at the LLC 114.

Particular embodiments may utilize a technique referred to herein as virtual hybrid cache (VHC) which involves retaining frequently dirty lines in L2 for longer periods of time, thereby eliminating a portion of dirty writes in the LLC. In particular embodiments, a VHC architecture may absorb writes that otherwise might have been repeatedly written to the LLC 114. Similar to a hybrid LLC approach, the VHC approach may result in reduced writes to the LLC 114, but VHC does not suffer from the extra overhead caused by an SRAM cache portion.

Unlike existing approaches that focus primarily on optimizations targeting write elimination for a given LLC size and architecture, various embodiments holistically solve the write latency induced performance bottlenecks by both eliminating writes as well as by reducing the interference of these writes on reads. Simulations of a particular embodiment utilizing the architectural techniques described herein indicated a 5% power reduction and 23% performance gain over a baseline 4-core system with an 8 MB STTRAM-based exclusive LLC having write latency of 20 ns; and a performance gain of 16% over a baseline STTRAM-based inclusive LLC. In comparison to an ideal STTRAM-based LLC that has SRAM-like write latency, simulations show that the architectural techniques may mitigate the performance impact of high write latency by almost 70%, thereby approaching SRAM-like performance while providing the high density, low cost, and low power enabled by NVM technologies.

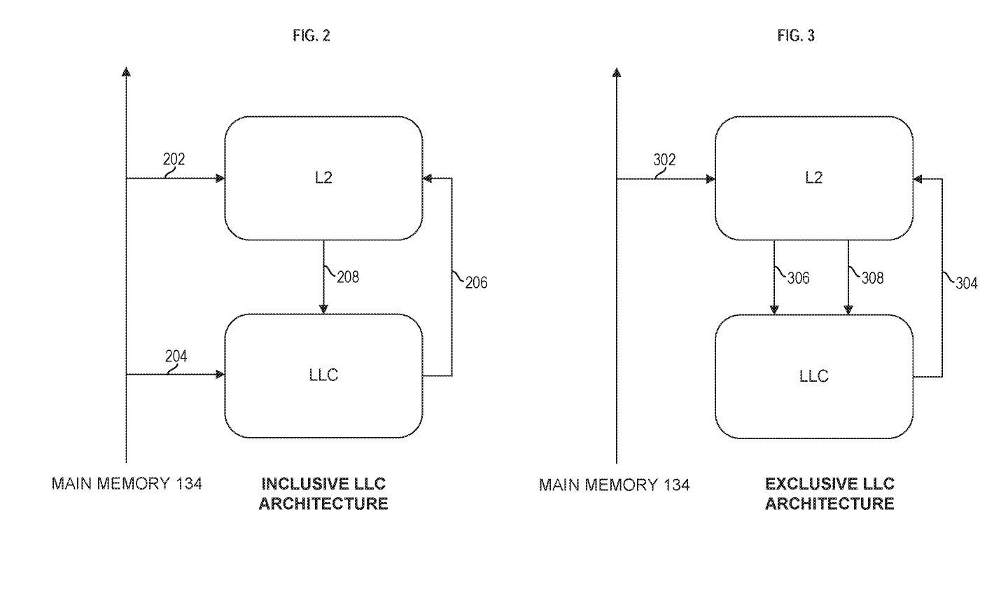

In various embodiments, LLC 114 may be an inclusive LLC or an exclusive LLC. FIG. 2 illustrates example communications involving an L2 cache and an inclusive NVM-LLC in accordance with certain embodiments. An LLC may be classified as inclusive or exclusive based on its inclusion relation with mid-level caches (e.g., the L2 cache). An inclusive LLC may duplicate every line in the mid-level caches within the LLC. This helps simplify coherence flows, although duplication comes at an overall reduced capacity. Inclusive LLCs have been the typical choice of most state-of-the-art commercial CPUs.

Writes in an inclusive LLC occur 1) when filling from main memory on an LLC miss and 2) for dirty victims (i.e., modified cache lines that are evicted) from L2. In an inclusive LLC architecture, the eviction of clean cache lines from L2 do not generate writes in the LLC (as these cache lines have already been written to the LLC at the time of filling from main memory).

In the embodiment depicted, an LLC miss may result in a write 202 from main memory to the L2 cache and a write 204 from main memory to the LLC. An LLC hit may result in a write 206 from the LLC to the L2 cache. A dirty victim in the L2 cache may result in a write 208 of the evicted cache line into the LLC.

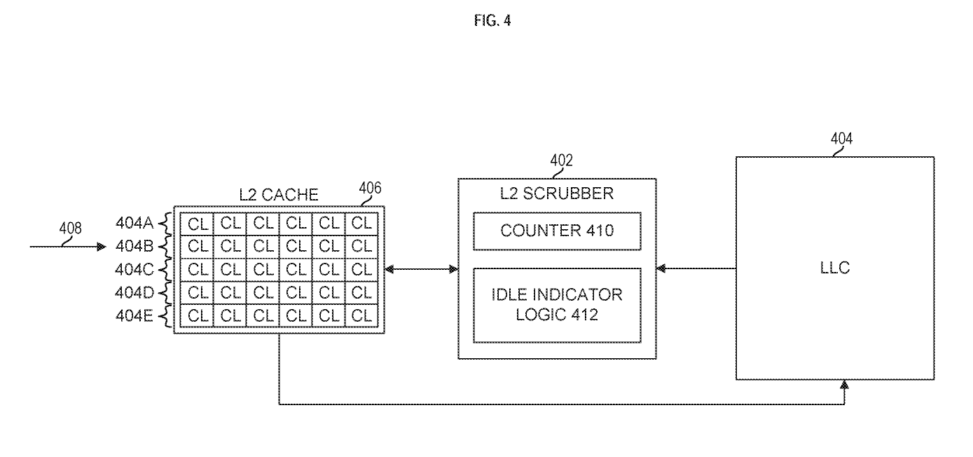

FIG. 3 illustrates example communications involving an L2 cache and an exclusive NVM-LLC in accordance with certain embodiments. In exclusive LLCs, both clean and dirty L2 (or other mid-level cache) victims are written to the LLC, while memory fills (in response to LLC misses) only occur in the L2. Write traffic in an exclusive LLC can be substantially higher as cache lines are deallocated (e.g., the space occupied by a deallocated cache line is made available for the storage of a different cache line) from the LLC on hits and are always written back when evicted from L2, regardless of whether they were dirty or clean. As the L2 (or other mid-level) cache size continues to grow, LLCs are being increasingly designed as exclusive, primarily because of the capacity benefits of not replicating cache lines between the L2 cache and the LLC. Although various embodiments herein may focus on an exclusive LLC architecture, the teachings of the present disclosure may also be applicable to any suitable LLC architectures (including inclusive LLC architectures).

In the embodiment depicted, an LLC miss may result in a write 302 from main memory to the L2 cache. An LLC hit may result in a write 304 from the LLC to the L2 cache. A clean victim in the L2 cache may result in a write 306 of the evicted cache line into the LLC and a dirty victim in the L2 cache may result in a write 308 of the evicted cache line into the LLC.

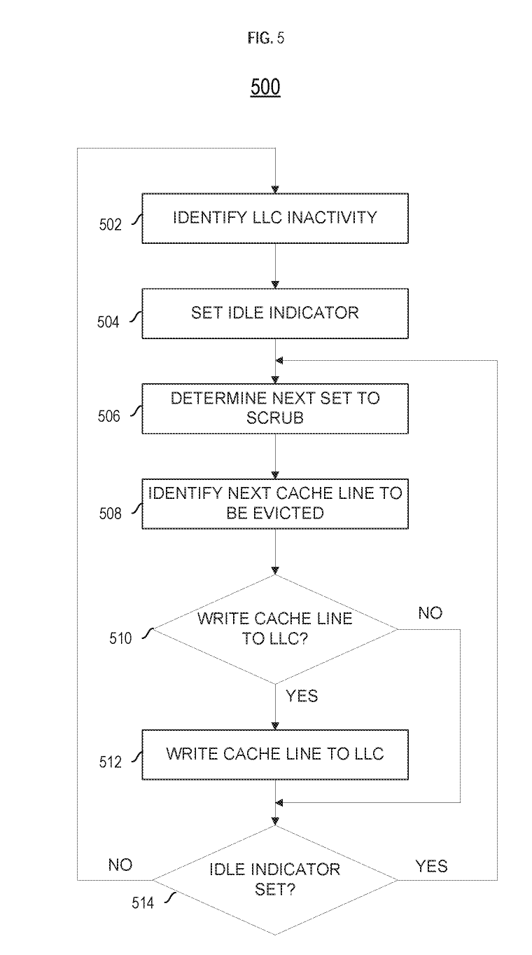

FIG. 4 illustrates an example L2 scrubber 402 in communication with an NVM-LLC 404 and an L2 cache 406 in accordance with certain embodiments. In the embodiment depicted, L2 cache 406 may comprise a plurality of sets (e.g., set 404A, set 404B, etc.) of cache lines (CL). L2 cache 406 may also maintain a pointer 408 to a next-to-scrub set. In various embodiments, any other mid-level cache may be utilized in a manner similar to the L2 cache 406.

Although the embodiment depicted illustrates a single L2 cache 406, a single L2 scrubber 402, and a single LLC 404, any number of these components may be resident on a processor. For example, a single L2 scrubber 402 may communicate with a plurality of L2 caches 406. As another example, a plurality of L2 scrubbers 402 may each be associated with a portion of an LLC 404 (e.g., an LLC slice) and may each communicate with one or more L2 caches. Thus, in a particular embodiment, LLC 404 may represent a portion (e.g., an LLC slice) of an LLC 114. In a particular embodiment, a single L2 scrubber communicates with (and aggregates information from) each LLC slice of an LLC 114 and communicates with each L2 cache.

The L2 scrubber 402 operates to mitigate the high write latency of the LLC by using low activity periods at the LLC to complete write operations, thereby reducing write interference in periods of high read bandwidth demand. That is, the L2 scrubber 402 may time shift some of the write requests that would normally be issued during a high activity period, to a low activity period preceding the high activity period. The performance of these eager write operations may be referred to as scrubbing. Although the L2 scrubber 402 is depicted as being separate from LLC 404 (and the logic implementing the L2 scrubber may or may not be co-located with LLC 404), at least in some embodiments, the L2 scrubber 402 may be considered as part of the LLC 404 (e.g., the functions performed by the L2 scrubber 402 may be considered as being performed by the LLC).

L2 scrubber 402 may include idle indicator logic 412 that monitors reads from and writes to the LLC 404. An idle indicator may be set by the idle indicator logic 412 during a period of relative inactivity at the LLC. For example, when the read and write queues of the LLC are empty for N cycles at the LLC (where N may be any suitable integer and in one embodiment is 40), the idle indicator logic 412 may set an idle indicator. In other examples, the idle indicator may be set according to any suitable measure of inactivity at the LLC, such as a number of queued read requests at the LLC, a number of queued write requests at the LLC, a number of cycles since a read request was received at the LLC, a number of cycles since a write request was received at the LLC, a number of cycles since a read queue of the LLC became empty, a number of cycles since a write queue of the LLC became empty, other measure of activity at the LLC, or any suitable combination thereof. In a particular embodiment, when the idle condition(s) of the LLC are met (such as any of the conditions described above or other suitable idle conditions), idle indicator logic 412 starts counter 410 (or reads the value of counter 410) and once the counter reaches a predetermined value (and the idle condition(s) remain set), the idle indicator logic 412 sets the idle indicator and the idle indicator is provided to L2 cache 406. In other embodiments, once one or more idle conditions are met, idle indicator logic 412 sets the idle indicator (i.e., it does not require the conditions to persist for a certain number of cycles).

In various embodiments, the idle indicator may be sent by the L2 scrubber 402 to all the L2 caches of a processor (or to any subset of L2 caches that communicate with the LLC 404 that is associated with the L2 scrubber 402). In a particular embodiment, the idle indicator remains set as long as the LLC is relatively inactive (e.g., based on any one or more of the criteria described above). In a particular example, the idle indicator remains set as long as no read request is received at the LLC and the number of write requests in a write queue of the LLC 404 remains below a predetermined threshold (e.g., 8 write requests). In various embodiments, the idle indicator may be trigger-based (e.g., it is sent to the L2 caches when it changes value) or may be sent periodically or continuously to the L2 caches regardless of whether its value has changed.

Upon receiving notification from an L2 scrubber 402 that the idle indicator has been set, an L2 cache 406 determines, via the current value of the pointer 408, the next set that should be scrubbed. The L2 cache 406 then determines the cache line of that set that would be the next cache line to be evicted. The next cache line to be evicted may be selected in any suitable manner. In one example, the cache line that is the least recently used (LRU) cache line may be the next cache line to be evicted. In other examples, the next cache line to be evicted is selected based on a most recently used (MRU) scheme, least frequently used scheme, re-reference interval prediction (RRIP) scheme, random scheme, or other suitable scheme. The selected cache line may be checked to determine whether the cache line was already scrubbed (i.e., written to the LLC 404 during a scrubbing operation), e.g., via an examination of a bit or other indicator stored in association with the cache line that indicates whether cache line was already scrubbed. If the selected cache line was not already scrubbed, the cache line is written to the LLC 404 and marked as scrubbed in the L2 cache 406. If the selected cache line was dirty (e.g., as indicated by a bit or other indicator stored in association with the cache line), it is set to clean in the L2 cache 406 (a subsequent write-back from the L1 cache will make the cache line dirty again and reset the scrubbed indicator for the cache line). The pointer 408 may then be updated to point to the next set to scrub. Various embodiments may result in the scrubbing of each LRU cache line of each set in the L2 cache (assuming that the idle indicator does not change values prior to completion of the scrubbing). If the idle indicator changes values (indicating the end of an idle period at the LLC 404), scrubbing is stopped. In various embodiments, idle indicator logic 412 may monitor the activity at LLC 404 and reset the idle indicator upon a determination that scrubbing should be paused. Scrubbing may be resumed from the set indicated by pointer 408 during the next idle period at the LLC 404.

In the next high activity period, when a scrubbed cache line in the L2 cache 406 is selected as a victim (i.e., for eviction), the cache line can be dropped without writing the cache line to the LLC 404 since it was previously written to the LLC 404 during the scrubbing operation. If LLC 404 is an inclusive LLC, only the dirty L2 cache lines are scrubbed because clean lines do not create additional writes at the LLC (since they are already stored at the LLC). For exclusive LLCs, both clean and dirty lines are scrubbed.

In a particular embodiment, a single L2 scrubber 402 is used for the entire LLC 404. L2 scrubber 402 aggregates the relevant information from all the LLC slices 114A-M and if all the LLC slices are idle for a certain period, then the L2 scrubber 402 sets the idle indicator and provides the set idle indicator to all of the L2 caches. A scrubbed or evicted cache line from an L2 cache may go to any of the LLC slices based on its address. As one example, a hashing function may be used on the address of the cache line to map a request to an LLC slice.

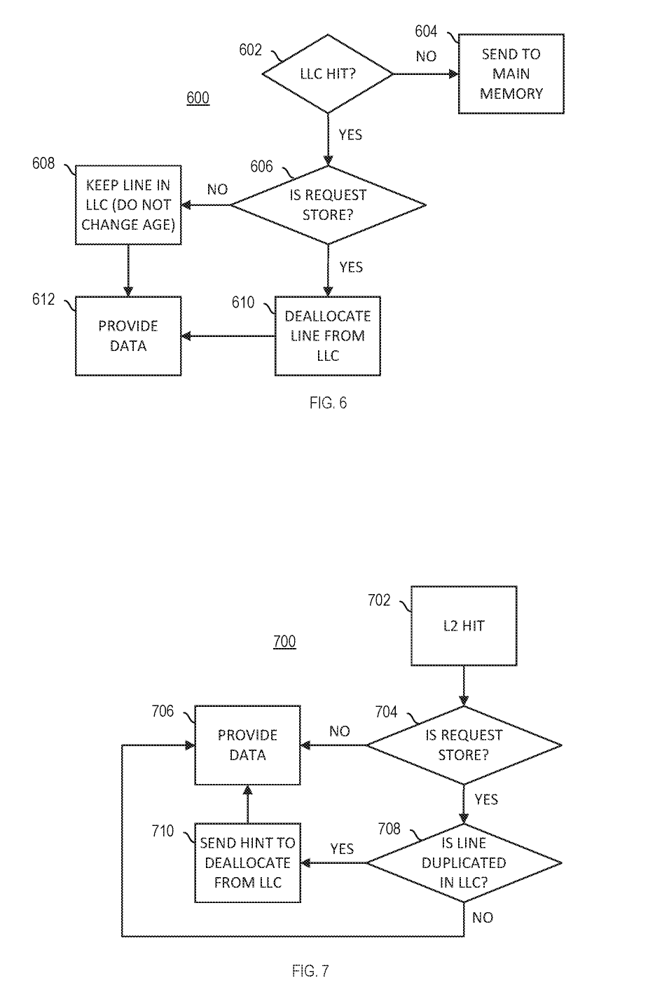

FIG. 5 illustrates an example flow 500 for performing an eager write to an NVM-LLC in accordance with certain embodiments. At 502, inactivity at the LLC is identified (e.g., using any of the methods described above). At 504, an idle indicator is set, e.g., by an L2 scrubber 402. The value of the idle indicator may be communicated to one or more L2 (or other mid-level) caches.

In response to receiving a notification that the idle indicator has been set, an L2 cache (or other mid-level cache) or logic in communication with the L2 cache may determine a next set of the L2 cache to scrub at 506, e.g., based on a pointer that cycles through the sets of the L2 cache. At 508, the next cache line that is to be evicted from the determined set (e.g., when the L2 cache is to add a new cache line to the set). At 510, a determination is made as to whether the identified cache line should be written to the LLC. For example, if the LLC is an inclusive LLC (in which fills from main memory are written to both the L2 cache and the LLC), then the L2 cache may write the cache line to the LLC if the cache line is dirty and the cache line has not yet been scrubbed (in various embodiments, the cache line may be stored with a first indication of whether the cache line is dirty or clean and a second indication of whether the cache line has been scrubbed or not and these indicators may be examined to determine whether the cache line is to be written to the LLC). As another example, if the LLC is an exclusive cache (in which fills from main memory are written to the L2 cache but not to the LLC), then the L2 cache may write the cache line to the LLC if the cache line has not yet been scrubbed (regardless of whether the cache line is dirty or clean). If a determination is made at 510 to write the cache line to the LLC, then the cache line is written to the LLC at 512 and the scrubbed indicator of the cache line is updated to reflect this scrub operation. Otherwise, the flow moves to 514. At 514, a determination is made as to whether the idle indicator for the LLC is still set. If the idle indicator is still set, scrubbing resumes with the next set at 506. Otherwise, the scrubbing operation ceases until LLC inactivity is again identified at 502.

The flow described in FIG. 5 is merely representative of operations that may occur in particular embodiments. In other embodiments, additional operations may be performed by the components of integrated circuit 100. Various embodiments of the present disclosure contemplate any suitable signaling mechanisms for accomplishing the functions described herein. Some of the operations illustrated in FIG. 5 may be repeated, combined, modified or deleted where appropriate. Additionally, operations may be performed in any suitable order without departing from the scope of particular embodiments.

In an exclusive LLC architecture, a read hit in the LLC deallocates the cache line from the LLC and moves it to the L2 cache. Upon an eviction from the L2 cache, this cache line may be written back to the LLC, regardless of whether it was clean or dirty. A subsequent hit in the LLC will move this line back to the L2. Writebacks due to such cache lines that frequently move between the L2 and the LLC may be referred to as frequent fills. Such fills may contribute a significant portion of the overall writes (sometimes being as high as 50% of the total writes at the LLC).

There are various applications that do not have enough low activity periods to successfully time shift writes. In order to reduce write congestion for such applications (or in general for any application), the actual number of writes that happen at the LLC may be reduced according to various embodiments of the present disclosure. Particular embodiments herein provide optimizations to a technique referred to as relaxed exclusivity which allows for some duplication between the L2 cache and an LLC which otherwise complies with an exclusive LLC architecture (e.g., fills from main memory are sent to the L2 cache and not the LLC). Such an architecture may be referred to as a relaxed exclusivity architecture.

A clean fill (i.e., the writing of a clean cache line to the LLC when the cache line is evicted from the L2 cache) may occur when an exclusive LLC architecture is used (clean fills generally are not used in an inclusive LLC architecture because the LLC already contains a copy of the cache line). In order to reduce frequent clean fills, cache lines may be duplicated between the L2 cache and the LLC (i.e., the same cache line may be stored in the L2 cache and the LLC). In a scheme known as loop-block aware policy (LAP), cache lines are not deallocated from the LLC upon a read hit, thereby duplicating some lines between the L2 and the LLC. This will eliminate all the clean fills after their first trip to the LLC. However, the disadvantage of such a scheme is LLC capacity loss due to duplication.

Various embodiments provide improvements to a relaxed exclusivity architecture to minimize such capacity losses. Based on the request type (for a particular cache line) which hits in the LLC, a decision may be made to not duplicate a line. For example, if the request is for a store, then there is no value in duplicating the cache line as it would be made dirty in the L2 and the LLC copy will be stale, thereby necessitating a future writeback from the L2. Hence such lines are not duplicated in the LLC. This is contrary to LAP, which always keeps the cache line in the LLC upon a hit.

Many applications lose performance if duplicated lines are prioritized in the LLC to stay longer due to capacity loss resulting from duplication. Thus, performance may be improved by duplicating only the cache lines that make short time interval trips between L2 and the LLC. If a cache line moves from the LLC to L2 and is retained in the L2 for a long time, the effective cache capacity will be reduced due to duplication of the cache line over a long time period. To reduce the duplication of such lines in the LLC, in various embodiments, the replacement age (e.g., an indication of the amount of time the cache line has been in the LLC) is not updated when the cache line is duplicated in the L2 (e.g., upon a hit in the LLC), thus leading to less duplication between the L2 cache and the LLC since the cache line will be subject to eviction sooner than it would have been if the replacement age had been updated. This is contrary to LAP, where duplicated lines are moved to the most recently used (MRU) position (e.g., the replacement age is reset) to reduce clean fills.

There may be many cases where a read request brings a cache line from the LLC into the L2, and a subsequent store makes this line dirty in the L1 cache. In various embodiments, as soon as the cache line get dirty in the L1 cache, a hint may be sent with a coherence packet to de-allocate a copy of the cache line in the LLC, thereby preventing an unnecessary duplication. In a particular embodiment, the hint may be sent when a store request for the line hits in the L2 cache. In a particular embodiment, the hint is sent only if the cache line is duplicated in the LLC and the determination of whether the line is duplicated is based on a one bit indicator stored with the cache line that is set if the line is duplicated in the LLC but not set if the line is not duplicated in the LLC.

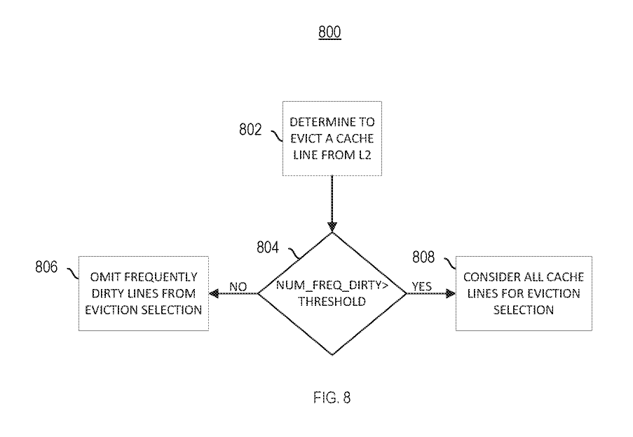

FIG. 6 illustrates an example flow 600 for implementing optimized relaxed exclusivity at an LLC in accordance with certain embodiments. The operations may be performed by the LLC or associated logic (e.g., cache controller 112). When a request for a cache line is received at the LLC, a determination is made at 602 as to whether the cache line is stored in the LLC. If the cache line is not stored in the LLC, then the request is sent to main memory at 604. If the cache line is stored in the LLC, then a determination is made as to whether the request is a read request or a store request at 606. If the request is a read request, then the cache line is kept in the LLC at 608 and the replacement age of the cache line is not changed. If the request is a store request, then the cache line is deallocated (e.g., deleted or marked for future deletion) from the LLC. The cache line is provided to the L2 cache at 612.

The flow described in FIG. 6 is merely representative of operations that may occur in particular embodiments. In other embodiments, additional operations may be performed by the components of integrated circuit 100. Various embodiments of the present disclosure contemplate any suitable signaling mechanisms for accomplishing the functions described herein. Some of the operations illustrated in FIG. 6 may be repeated, combined, modified or deleted where appropriate. Additionally, operations may be performed in any suitable order without departing from the scope of particular embodiments.

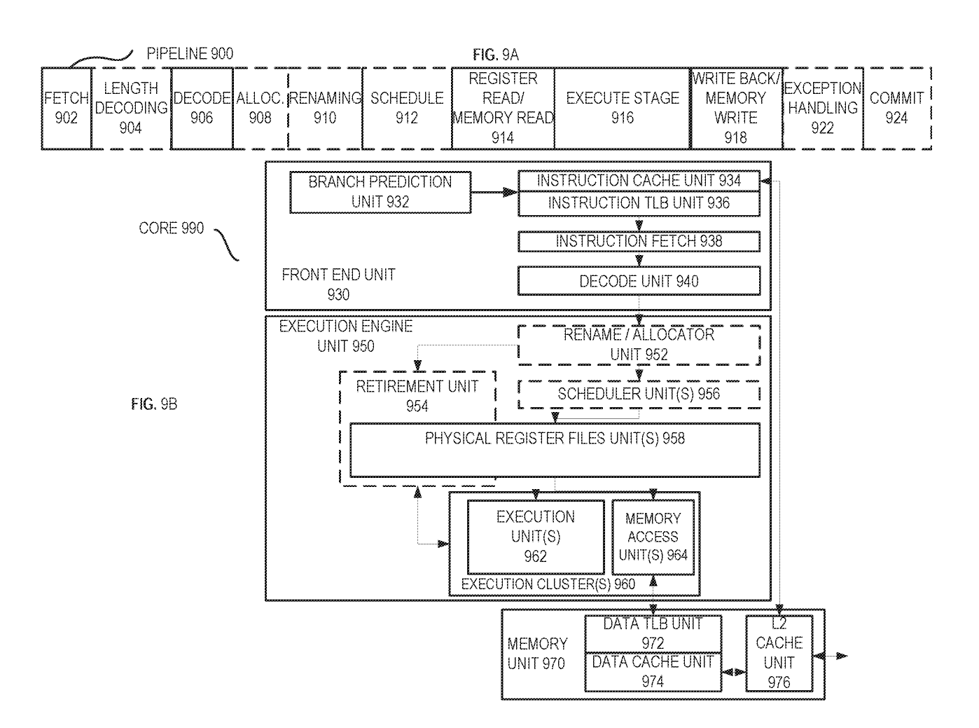

FIG. 7 illustrates an example flow 700 for implementing optimized relaxed exclusivity at an L2 cache in accordance with certain embodiments. The operations may be performed by an L2 cache or associated logic (e.g., a cache controller). At 702, a requested cache line (e.g., from an L1 cache) results in a hit in the L2 cache. At 704, it is determined whether the request is a store request. If it is not (i.e., if it is a read request), the cache line is provided to the L1 cache at 706. If the request is a store request, a determination is made at 708 as to whether the cache line is duplicated in the LLC. If the cache line is not duplicated, then the cache line is provided to the L1 cache at 706. If the cache line is duplicated in the LLC, then a hint is sent to the LLC (or associated logic) to cause the LLC to deallocate the cache line from the LLC. The cache line is also provided to the L1 cache at 706.

The flow described in FIG. 7 is merely representative of operations that may occur in particular embodiments. In other embodiments, additional operations may be performed by the components of integrated circuit 100. Various embodiments of the present disclosure contemplate any suitable signaling mechanisms for accomplishing the functions described herein. Some of the operations illustrated in FIG. 7 may be repeated, combined, modified or deleted where appropriate. Additionally, operations may be performed in any suitable order without departing from the scope of particular embodiments.

To reduce frequent fills at the LLC, various embodiments may utilize a Virtual Hybrid Cache (VHC). Unlike a true hybrid cache that uses a dedicated SRAM cache for frequent fills, the VHC simply borrows some capacity from the L2 and the LLC. To reduce writebacks due to dirty L2 evictions, a VHC may retain cache lines that create frequent dirty fills in the L2 cache so that multiple L1 writebacks may merge in the L2 cache.

To reduce frequent dirty trips (from the L2 cache to the LLC), particular cache lines may be classified as “frequently dirty”, and the frequently dirty cache lines may be given preference to stay in the L2 over cache lines not classified as frequently dirty when a cache line is evicted. Any suitable criteria may be used to determine whether to classify a cache line as frequently dirty. For example, actual or predicted dirty trips of the cache line and/or related cache lines from the L2 cache to the LLC may be used to determine whether a cache line is classified as frequently dirty. In a particular embodiment, the classification may be based on any suitable combination of characteristics of the predictor described in “Adaptive Placement and Migration Policy for an STT-RAM-Based Hybrid Cache” by Zhe Wang, et al., published in the 2014 IEEE 20th International Symposium on High Performance Computer Architecture (HPCA).

By keeping the frequently dirty lines in the L2 cache for longer periods of time, many writes to the cache line may merge in the L2 cache without being written to the LLC after each update of the cache line in the L2 cache. In a particular embodiment, when a cache line of a set of cache lines of an L2 cache is to be evicted, a count of the number of frequently dirty lines in the L2 cache is determined. If this count is lower than W (where W may be any suitable integer), then the frequently dirty lines of the set are not considered candidates for eviction during victim selection. Otherwise if the count is equal or higher than W, then all the cache lines of the set, including the frequently dirty cache lines, are considered candidates for eviction during victim selection. In a particular embodiment, W=2.

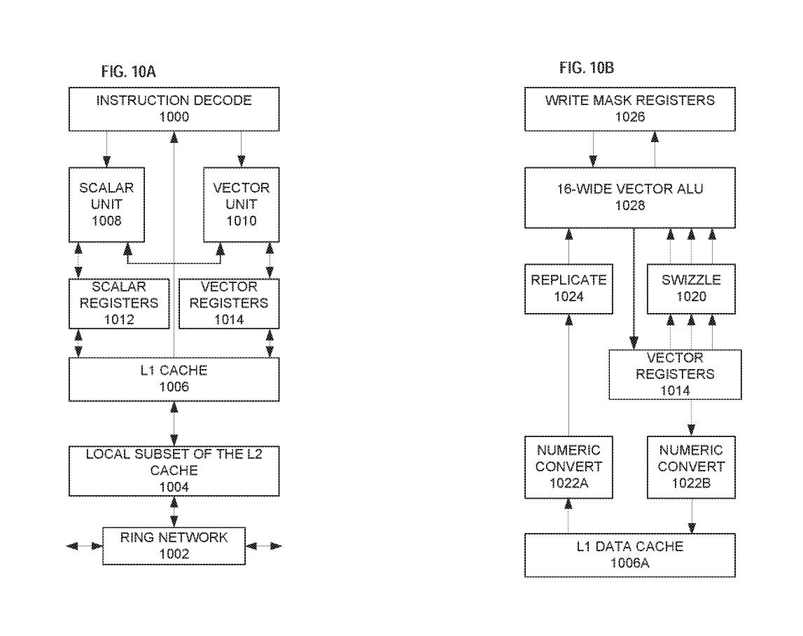

FIG. 8 illustrates an example flow 800 for reducing writes caused by frequently dirty cache lines in accordance with certain embodiments. At 802, a determination is made to evict a cache line from an L2 cache. As one example, the determination may be made to evict a cache line from a set of cache lines of an L2 cache (where the L2 cache may include one or more sets of cache lines).

At 804, a determination is made as to whether the number of frequently dirty cache lines in the set is above a predetermined threshold (e.g., 2). If the number of frequently dirty cache lines is not above the threshold, then the frequently dirty cache lines are omitted from the eviction selection at 806. That is, even if one of the frequently dirty cache lines would normally have been the next cache line to be evicted, the frequently dirty cache line is not evicted, but a cache line that is not marked as frequently dirty is instead selected for eviction. If the number of frequently dirty cache lines is above the threshold, then all cache lines of the set (including any frequently dirty cache lines) are included in the eviction selection process.

The flow described in FIG. 8 is merely representative of operations that may occur in particular embodiments. In other embodiments, additional operations may be performed by the components of integrated circuit 100. Various embodiments of the present disclosure contemplate any suitable signaling mechanisms for accomplishing the functions described herein. Some of the operations illustrated in FIG. 8 may be repeated, combined, modified or deleted where appropriate. Additionally, operations may be performed in any suitable order without departing from the scope of particular embodiments.

The figures below detail exemplary architectures and systems to implement embodiments of the above. In some embodiments, one or more hardware components and/or instructions described above are emulated as detailed below, or implemented as software modules.

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

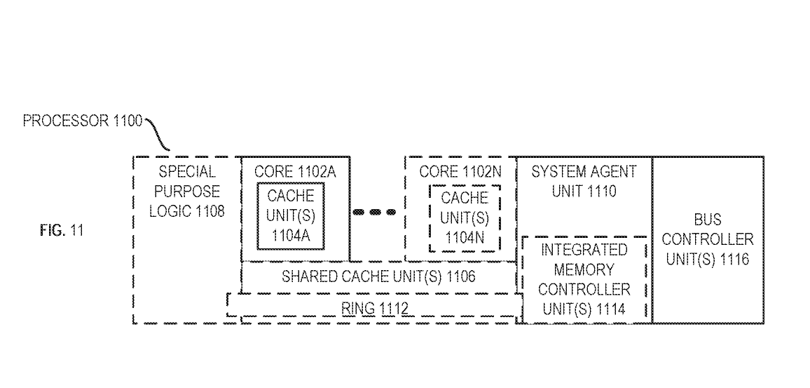

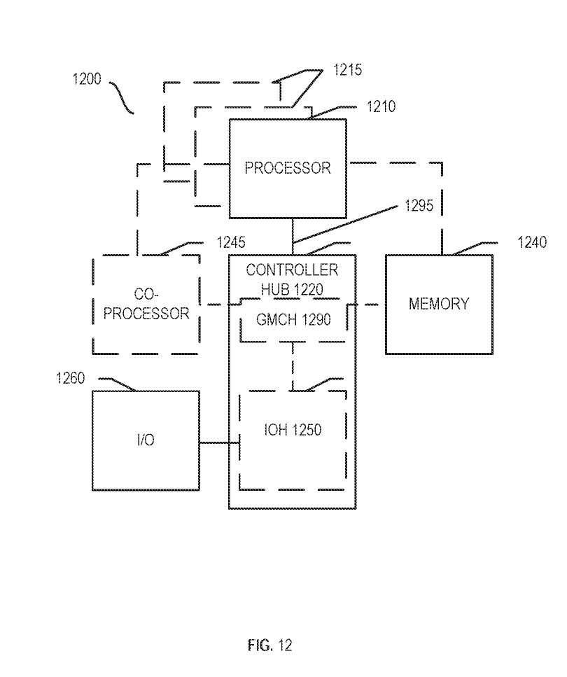

FIG. 9A is a block diagram illustrating both an exemplary in-order pipeline and an exemplary register renaming, out-of-order issue/execution pipeline according to embodiments of the disclosure. FIG. 9B is a block diagram illustrating both an exemplary embodiment of an in-order architecture core and an exemplary register renaming, out-of-order issue/execution architecture core to be included in a processor according to embodiments of the disclosure. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, a length decode stage 904, a decode stage 906, an allocation stage 908, a renaming stage 910, a scheduling (also known as a dispatch or issue) stage 912, a register read/memory read stage 914, an execute stage 916, a write back/memory write stage 918, an exception handling stage 922, and a commit stage 924.

FIG. 9B shows processor core 990 including a front end unit 930 coupled to an execution engine unit 950, and both are coupled to a memory unit 970. The core 990 may be a reduced instruction set computing (RISC) core, a complex instruction set computing (CISC) core, a very long instruction word (VLIW) core, or a hybrid or alternative core type. As yet another option, the core 990 may be a special-purpose core, such as, for example, a network or communication core, compression and/or decompression engine, coprocessor core, general purpose computing graphics processing unit (GPGPU) core, graphics core, or the like.

The front end unit 930 includes a branch prediction unit 932 coupled to an instruction cache unit 934, which is coupled to an instruction translation lookaside buffer (TLB) 936, which is coupled to an instruction fetch unit 938, which is coupled to a decode unit 940. The decode unit 940 (or decoder) may decode instructions, and generate as an output one or more micro-operations, micro-code entry points, microinstructions, other instructions, or other control signals, which are decoded from, or which otherwise reflect, or are derived from, the original instructions. The decode unit 940 may be implemented using various different mechanisms. Examples of suitable mechanisms include, but are not limited to, look-up tables, hardware implementations, programmable logic arrays (PLAs), microcode read only memories (ROMs), etc. In one embodiment, the core 990 includes a microcode ROM or other medium that stores microcode for certain macroinstructions (e.g., in decode unit 940 or otherwise within the front end unit 930). The decode unit 940 is coupled to a rename/allocator unit 952 in the execution engine unit 950.

The execution engine unit 950 includes the rename/allocator unit 952 coupled to a retirement unit 954 and a set of one or more scheduler unit(s) 956. The scheduler unit(s) 956 represents any number of different schedulers, including reservations stations, central instruction window, etc. The scheduler unit(s) 956 is coupled to the physical register file(s) unit(s) 958. Each of the physical register file(s) units 958 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 958 comprises a vector registers unit, a write mask registers unit, and a scalar registers unit. These register units may provide architectural vector registers, vector mask registers, and general purpose registers. The physical register file(s) unit(s) 958 is overlapped by the retirement unit 954 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 954 and the physical register file(s) unit(s) 958 are coupled to the execution cluster(s) 960. The execution cluster(s) 960 includes a set of one or more execution units 962 and a set of one or more memory access units 964. The execution units 962 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 956, physical register file(s) unit(s) 958, and execution cluster(s) 960 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 964). It should also be understood that where separate pipelines are used, one or more of these pipelines may be out-of-order issue/execution and the rest in-order.

The set of memory access units 964 is coupled to the memory unit 970, which includes a data TLB unit 972 coupled to a data cache unit 974 coupled to a level 2 (L2) cache unit 976. In one exemplary embodiment, the memory access units 964 may include a load unit, a store address unit, and a store data unit, each of which is coupled to the data TLB unit 972 in the memory unit 970. The instruction cache unit 934 is further coupled to a level 2 (L2) cache unit 976 in the memory unit 970. The L2 cache unit 976 is coupled to one or more other levels of cache and eventually to a main memory.

By way of example, the exemplary register renaming, out-of-order issue/execution core architecture may implement the pipeline 900 as follows: 1) the instruction fetch 938 performs the fetch and length decoding stages 902 and 904; 2) the decode unit 940 performs the decode stage 906; 3) the rename/allocator unit 952 performs the allocation stage 908 and renaming stage 910; 4) the scheduler unit(s) 956 performs the schedule stage 912; 5) the physical register file(s) unit(s) 958 and the memory unit 970 perform the register read/memory read stage 914; the execution cluster 960 perform the execute stage 916; 6) the memory unit 970 and the physical register file(s) unit(s) 958 perform the write back/memory write stage 918; 7) various units may be involved in the exception handling stage 922; and 8) the retirement unit 954 and the physical register file(s) unit(s) 958 perform the commit stage 924.

The core 990 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 990 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 934/974 and a shared L2 cache unit 976, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

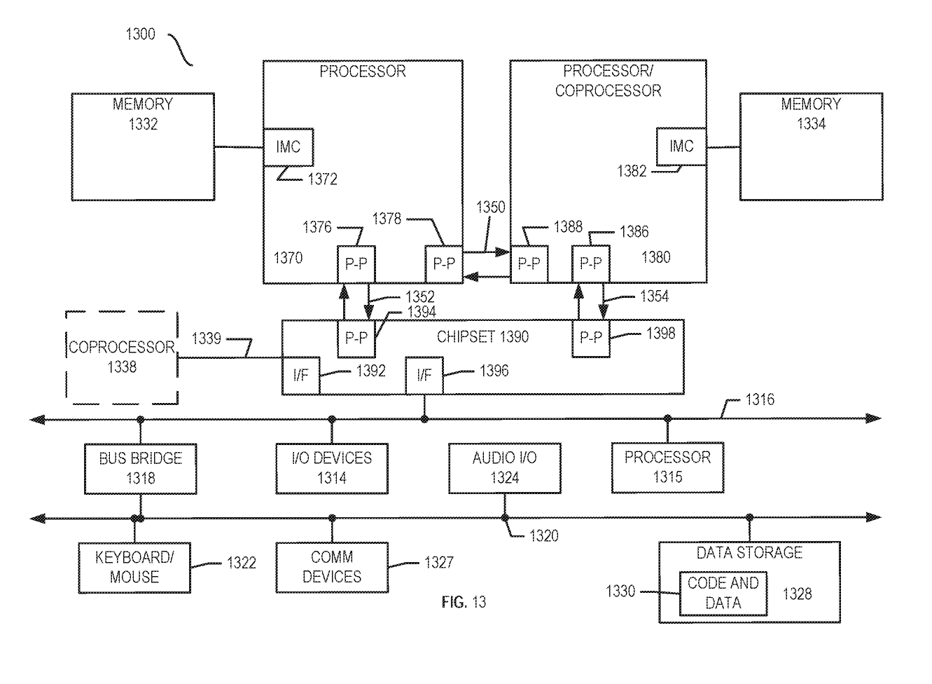

FIGS. 10A-B illustrate a block diagram of a more specific exemplary in-order core architecture, which core would be one of several logic blocks (potentially including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 10A is a block diagram of a single processor core, along with its connection to the on-die interconnect network 1002 and with its local subset of the Level 2 (L2) cache 1004, according to various embodiments. In one embodiment, an instruction decoder 1000 supports the x86 instruction set with a packed data instruction set extension. An L1 cache 1006 allows low-latency accesses to cache memory into the scalar and vector units. While in one embodiment (to simplify the design), a scalar unit 1008 and a vector unit 1010 use separate register sets (respectively, scalar registers 1012 and vector registers 1014) and data transferred between them is written to memory and then read back in from a level 1 (L1) cache 1006, alternative embodiments may use a different approach (e.g., use a single register set or include a communication path that allow data to be transferred between the two register files without being written and read back).

The local subset of the L2 cache 1004 is part of a global L2 cache that is divided into separate local subsets (in some embodiments one per processor core). Each processor core has a direct access path to its own local subset of the L2 cache 1004. Data read by a processor core is stored in its L2 cache subset 1004 and can be accessed quickly, in parallel with other processor cores accessing their own local L2 cache subsets. Data written by a processor core is stored in its own L2 cache subset 1004 and is flushed from other subsets, if necessary. The ring network ensures coherency for shared data. The ring network is bi-directional to allow agents such as processor cores, L2 caches and other logic blocks to communicate with each other within the chip. In a particular embodiment, each ring data-path is 1012-bits wide per direction.

FIG. 10B is an expanded view of part of the processor core in FIG. 10A according to embodiments. FIG. 10B includes an L1 data cache 1006A (part of the L1 cache 1006), as well as more detail regarding the vector unit 1010 and the vector registers 1014. Specifically, the vector unit 1010 is a 16-wide vector processing unit (VPU) (see the 16-wide ALU 1028), which executes one or more of integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating resulting vector writes.

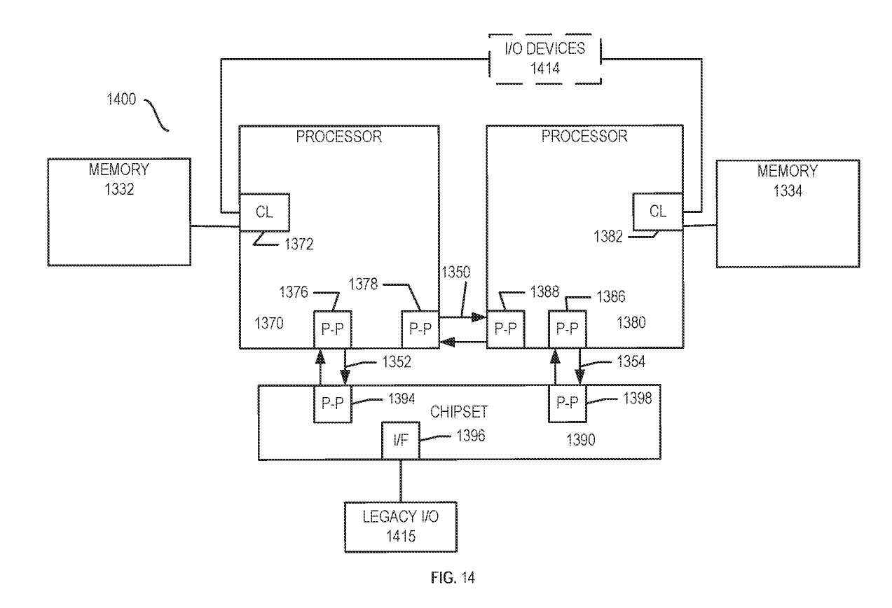

FIG. 11 is a block diagram of a processor 1100 that may have more than one core, may have an integrated memory controller, and may have integrated graphics according to various embodiments. The solid lined boxes in FIG. 11 illustrate a processor 1100 with a single core 1102A, a system agent 1110, and a set of one or more bus controller units 1116; while the optional addition of the dashed lined boxes illustrates an alternative processor 1100 with multiple cores 1102A-N, a set of one or more integrated memory controller unit(s) 1114 in the system agent unit 1110, and special purpose logic 1108.

Thus, different implementations of the processor 1100 may include: 1) a CPU with the special purpose logic 1108 being integrated graphics and/or scientific (throughput) logic (which may include one or more cores), and the cores 1102A-N being one or more general purpose cores (e.g., general purpose in-order cores, general purpose out-of-order cores, or a combination of the two); 2) a coprocessor with the cores 1102A-N being a large number of special purpose cores intended primarily for graphics and/or scientific (throughput); and 3) a coprocessor with the cores 1102A-N being a large number of general purpose in-order cores. Thus, the processor 1100 may be a general-purpose processor, coprocessor or special-purpose processor, such as, for example, a network or communication processor, compression and/or decompression engine, graphics processor, GPGPU (general purpose graphics processing unit), a high-throughput many integrated core (MIC) coprocessor (e.g., including 30 or more cores), embedded processor, or other fixed or configurable logic that performs logical operations. The processor may be implemented on one or more chips. The processor 1100 may be a part of and/or may be implemented on one or more substrates using any of a number of process technologies, such as, for example, BiCMOS, CMOS, or NMOS.

In various embodiments, a processor may include any number of processing elements that may be symmetric or asymmetric. In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The memory hierarchy includes one or more levels of cache within the cores, a set or one or more shared cache units 1106, and external memory (not shown) coupled to the set of integrated memory controller units 1114. The set of shared cache units 1106 may include one or more mid-level caches, such as level 2 (L2), level 3 (L3), level 4 (L4), or other levels of cache, a last level cache (LLC), and/or combinations thereof. While in one embodiment a ring based interconnect unit 1112 interconnects the special purpose logic (e.g., integrated graphics logic) 1108, the set of shared cache units 1106, and the system agent unit 1110/integrated memory controller unit(s) 1114, alternative embodiments may use any number of well-known techniques for interconnecting such units. In one embodiment, coherency is maintained between one or more cache units 1106 and cores 1102A-N.

In some embodiments, one or more of the cores 1102A-N are capable of multi-threading. The system agent 1110 includes those components coordinating and operating cores 1102A-N. The system agent unit 1110 may include for example a power control unit (PCU) and a display unit. The PCU may be or include logic and components needed for regulating the power state of the cores 1102A-N and the special purpose logic 1108. The display unit is for driving one or more externally connected displays.

The cores 1102A-N may be homogenous or heterogeneous in terms of architecture instruction set; that is, two or more of the cores 1102A-N may be capable of executing the same instruction set, while others may be capable of executing only a subset of that instruction set or a different instruction set.

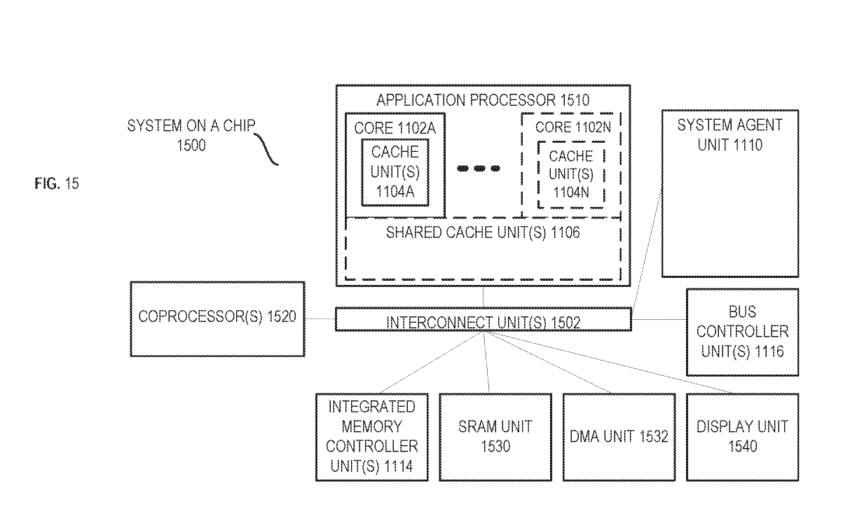

FIGS. 12-15 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable for performing the methods described in this disclosure. In general, a huge variety of systems or electronic devices capable of incorporating a processor and/or other execution logic as disclosed herein are generally suitable.

FIG. 12 depicts a block diagram of a system 1200 in accordance with one embodiment of the present disclosure. The system 1200 may include one or more processors 1210, 1215, which are coupled to a controller hub 1220. In one embodiment the controller hub 1220 includes a graphics memory controller hub (GMCH) 1290 and an Input/Output Hub (IOH) 1250 (which may be on separate chips or the same chip); the GMCH 1290 includes memory and graphics controllers coupled to memory 1240 and a coprocessor 1245; the IOH 1250 couples input/output (I/O) devices 1260 to the GMCH 1290. Alternatively, one or both of the memory and graphics controllers are integrated within the processor (as described herein), the memory 1240 and the coprocessor 1245 are coupled directly to the processor 1210, and the controller hub 1220 is a single chip comprising the IOH 1250.

The optional nature of additional processors 1215 is denoted in FIG. 12 with broken lines. Each processor 1210, 1215 may include one or more of the processing cores described herein and may be some version of the processor 1100.

The memory 1240 may be, for example, dynamic random access memory (DRAM), phase change memory (PCM), other suitable memory, or any combination thereof. The memory 1240 may store any suitable data, such as data used by processors 1210, 1215 to provide the functionality of computer system 1200. For example, data associated with programs that are executed or files accessed by processors 1210, 1215 may be stored in memory 1240. In various embodiments, memory 1240 may store data and/or sequences of instructions that are used or executed by processors 1210, 1215.

In at least one embodiment, the controller hub 1220 communicates with the processor(s) 1210, 1215 via a multi-drop bus, such as a frontside bus (FSB), point-to-point interface such as QuickPath Interconnect (QPI), or similar connection 1295.

In one embodiment, the coprocessor 1245 is a special-purpose processor, such as, for example, a high-throughput MIC processor, a network or communication processor, compression and/or decompression engine, graphics processor, GPGPU, embedded processor, or the like. In one embodiment, controller hub 1220 may include an integrated graphics accelerator.

There can be a variety of differences between the physical resources 1210, 1215 in terms of a spectrum of metrics of merit including architectural, microarchitectural, thermal, power consumption characteristics, and the like.

In one embodiment, the processor 1210 executes instructions that control data processing operations of a general type. Embedded within the instructions may be coprocessor instructions. The processor 1210 recognizes these coprocessor instructions as being of a type that should be executed by the attached coprocessor 1245. Accordingly, the processor 1210 issues these coprocessor instructions (or control signals representing coprocessor instructions) on a coprocessor bus or other interconnect, to coprocessor 1245. Coprocessor(s) 1245 accept and execute the received coprocessor instructions.

FIG. 13 depicts a block diagram of a first more specific exemplary system 1300 in accordance with an embodiment of the present disclosure. As shown in FIG. 13, multiprocessor system 1300 is a point-to-point interconnect system, and includes a first processor 1370 and a second processor 1380 coupled via a point-to-point interconnect 1350. Each of processors 1370 and 1380 may be some version of the processor 1100. In one embodiment of the disclosure, processors 1370 and 1380 are respectively processors 1210 and 1215, while coprocessor 1338 is coprocessor 1245. In another embodiment, processors 1370 and 1380 are respectively processor 1210 and coprocessor 1245.

Processors 1370 and 1380 are shown including integrated memory controller (IMC) units 1372 and 1382, respectively. Processor 1370 also includes as part of its bus controller units point-to-point (P-P) interfaces 1376 and 1378; similarly, second processor 1380 includes P-P interfaces 1386 and 1388. Processors 1370, 1380 may exchange information via a point-to-point (P-P) interface 1350 using P-P interface circuits 1378, 1388. As shown in FIG. 13, IMCs 1372 and 1382 couple the processors to respective memories, namely a memory 1332 and a memory 1334, which may be portions of main memory locally attached to the respective processors.

Processors 1370, 1380 may each exchange information with a chipset 1390 via individual P-P interfaces 1352, 1354 using point to point interface circuits 1376, 1394, 1386, 1398. Chipset 1390 may optionally exchange information with the coprocessor 1338 via a high-performance interface 1339. In one embodiment, the coprocessor 1338 is a special-purpose processor, such as, for example, a high-throughput MIC processor, a network or communication processor, compression and/or decompression engine, graphics processor, GPGPU, embedded processor, or the like.

A shared cache (not shown) may be included in either processor or outside of both processors, yet connected with the processors via a P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present disclosure is not so limited.

As shown in FIG. 13, various I/O devices 1314 may be coupled to first bus 1316, along with a bus bridge 1318 which couples first bus 1316 to a second bus 1320. In one embodiment, one or more additional processor(s) 1315, such as coprocessors, high-throughput MIC processors, GPGPU's, accelerators (such as, e.g., graphics accelerators or digital signal processing (DSP) units), field programmable gate arrays, or any other processor, are coupled to first bus 1316. In one embodiment, second bus 1320 may be a low pin count (LPC) bus. Various devices may be coupled to a second bus 1320 including, for example, a keyboard and/or mouse 1322, communication devices 1327 and a storage unit 1328 such as a disk drive or other mass storage device which may include instructions/code and data 1330, in one embodiment. Further, an audio I/O 1324 may be coupled to the second bus 1320. Note that other architectures are contemplated by this disclosure. For example, instead of the point-to-point architecture of FIG. 13, a system may implement a multi-drop bus or other such architecture.

FIG. 14 depicts a block diagram of a second more specific exemplary system 1400 in accordance with an embodiment of the present disclosure. Similar elements in FIGS. 13 and 14 bear similar reference numerals, and certain aspects of FIG. 13 have been omitted from FIG. 14 in order to avoid obscuring other aspects of FIG. 14.

FIG. 14 illustrates that the processors 1370, 1380 may include integrated memory and I/O control logic (“CL”) 1372 and 1382, respectively. Thus, the CL 1372, 1382 include integrated memory controller units and include I/O control logic. FIG. 14 illustrates that not only are the memories 1332, 1334 coupled to the CL 1372, 1382, but also that I/O devices 1414 are also coupled to the control logic 1372, 1382. Legacy I/O devices 1415 are coupled to the chipset 1390.

FIG. 15 depicts a block diagram of a SoC 1500 in accordance with an embodiment of the present disclosure. Similar elements in FIG. 11 bear similar reference numerals. Also, dashed lined boxes are optional features on more advanced SoCs. In FIG. 15, an interconnect unit(s) 1502 is coupled to: an application processor 1510 which includes a set of one or more cores 202A-N and shared cache unit(s) 1106; a system agent unit 1110; a bus controller unit(s) 1116; an integrated memory controller unit(s) 1114; a set or one or more coprocessors 1520 which may include integrated graphics logic, an image processor, an audio processor, and a video processor; an static random access memory (SRAM) unit 1530; a direct memory access (DMA) unit 1532; and a display unit 1540 for coupling to one or more external displays. In one embodiment, the coprocessor(s) 1520 include a special-purpose processor, such as, for example, a network or communication processor, compression and/or decompression engine, GPGPU, a high-throughput MIC processor, embedded processor, or the like.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

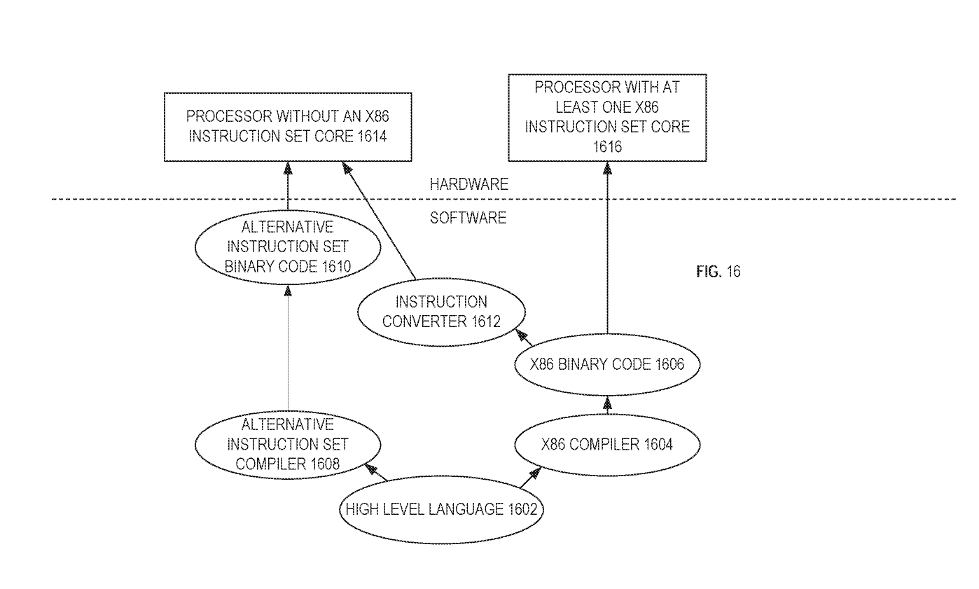

FIG. 16 is a block diagram contrasting the use of a software instruction converter to convert binary instructions in a source instruction set to binary instructions in a target instruction set according to embodiments of the disclosure. In the illustrated embodiment, the instruction converter is a software instruction converter, although alternatively the instruction converter may be implemented in software, firmware, hardware, or various combinations thereof. FIG. 16 shows a program in a high level language 1602 may be compiled using an x86 compiler 1604 to generate x86 binary code 1606 that may be natively executed by a processor with at least one x86 instruction set core 1616. The processor with at least one x86 instruction set core 1616 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1604 represents a compiler that is operable to generate x86 binary code 1606 (e.g., object code) that can, with or without additional linkage processing, be executed on the processor with at least one x86 instruction set core 1616. Similarly, FIG. 16 shows the program in the high level language 1602 may be compiled using an alternative instruction set compiler 1608 to generate alternative instruction set binary code 1610 that may be natively executed by a processor without at least one x86 instruction set core 1614 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1612 is used to convert the x86 binary code 1606 into code that may be natively executed by the processor without an x86 instruction set core 1614. This converted code is not likely to be the same as the alternative instruction set binary code 1610 because an instruction converter capable of this is difficult to make; however, the converted code will accomplish the general operation and be made up of instructions from the alternative instruction set. Thus, the instruction converter 1612 represents software, firmware, hardware, or a combination thereof that, through emulation, simulation or any other process, allows a processor or other electronic device that does not have an x86 instruction set processor or core to execute the x86 binary code 1606.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the manufacture of the described hardware.

In any representation of the design, the data representing the design may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

In various embodiments, a medium storing a representation of the design may be provided to a manufacturing system (e.g., a semiconductor manufacturing system capable of manufacturing an integrated circuit and/or related components). The design representation may instruct the system to manufacture a device capable of performing any combination of the functions described above. For example, the design representation may instruct the system regarding which components to manufacture, how the components should be coupled together, where the components should be placed on the device, and/or regarding other suitable specifications regarding the device to be manufactured.

Thus, one or more aspects of at least one embodiment may be implemented by representative instructions stored on a machine-readable medium which represents various logic within the processor, which when read by a machine causes the machine to fabricate logic to perform the techniques described herein. Such representations, often referred to as “IP cores” may be stored on a non-transitory tangible machine readable medium and supplied to various customers or manufacturing facilities to load into the fabrication machines that manufacture the logic or processor.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code, such as code 1330 illustrated in FIG. 13, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In various embodiments, the language may be a compiled or interpreted language.

The embodiments of methods, hardware, software, firmware or code set forth above may be implemented via instructions or code stored on a machine-accessible, machine readable, computer accessible, or computer readable medium which are executable (or otherwise accessible) by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information therefrom.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Logic may be used to implement any of the flows (e.g., flows 500, 600, 700, or 800) or functionality of any of the various components depicted throughout the figures, such as cache controller 112, any of the caches described herein, L2 scrubber 402, (and the various logical components therein), or other component described herein. “Logic” may refer to hardware, firmware, software and/or combinations of each to perform one or more functions. As an example, logic may include hardware, such as a micro-controller or processor, associated with a non-transitory medium to store code adapted to be executed by the micro-controller or processor. Therefore, reference to logic, in one embodiment, refers to the hardware, which is specifically configured to recognize and/or execute the code to be held on a non-transitory medium. Furthermore, in another embodiment, use of logic refers to the non-transitory medium including the code, which is specifically adapted to be executed by the microcontroller to perform predetermined operations. And as can be inferred, in yet another embodiment, the term logic (in this example) may refer to the combination of the hardware and the non-transitory medium. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components, which may be implemented by, e.g., transistors. In some embodiments, logic may also be fully embodied as software. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. Often, logic boundaries that are illustrated as separate commonly vary and potentially overlap. For example, first and second logic may share hardware, software, firmware, or a combination thereof, while potentially retaining some independent hardware, software, or firmware.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

In at least one embodiment, a processor comprises a processing core; a last level cache (LLC); and a mid-level cache to determine that an idle indicator has been set, wherein the idle indicator is set based on an amount of activity at the LLC; and based on the determination that the idle indicator has been set, identify a first cache line to be evicted from a first set of cache lines of the mid-level cache and send a request to write the first cache line to the LLC.

In an embodiment, the mid-level cache is to, based on the determination that the idle indicator has been set, identify a second cache line to be evicted from a second set of cache lines of the mid-level cache and send a request to write the second cache line to the LLC. In an embodiment, the processor comprises an L2 scrubber to set the idle indicator when a request queue of the LLC remains empty for a predetermined number of cycles. In an embodiment, the processor comprises an L2 scrubber to reset the idle indicator when a read request is received at the LLC. In an embodiment, the processor comprises an L2 scrubber to reset the idle indicator when the number of write requests in a request queue of the LLC exceeds a predetermined threshold. In an embodiment, the mid-level cache is to, based on the determination that the idle indicator has been set, identify a third cache line to be evicted from a third set of cache lines of the mid-level cache and determine not to send a request to write the third cache line to the LLC based on a determination that the LLC already includes the third cache line In an embodiment, the LLC is to receive a request for a cache line from the mid-level cache; and based on a determination that the request is a store request, deallocate the requested cache line from the LLC. In an embodiment, the LLC is to receive a request for a cache line from the mid-level cache; and based on a determination that the request is a read request, preserve the cache line in the LLC without changing a replacement age of the cache line. In an embodiment, the mid-level cache is to receive a request for a cache line from a level one cache; and based on a determination that the request is a store request and the requested cache line is duplicated in the LLC, send a hint to the LLC to deallocate the cache line. In an embodiment, the mid-level cache is to, based on a determination that a cache line is to be evicted from a set of cache lines of the mid-level cache, determine whether a number of frequently dirty cache lines of the set is below a predetermined threshold; and omit the frequently dirty lines from eviction selection when the number of frequently dirty cache lines is below the predetermined threshold.

In at least one embodiment, a method comprises determining, by a mid-level cache, that an idle indicator has been set, wherein the idle indicator is set based on an amount of activity at a last level cache (LLC); and based on the determination that the idle indicator has been set, identifying a first cache line to be evicted from a first set of cache lines of the mid-level cache and sending a request to write the first cache line to the LLC.

In an embodiment, the method further comprises based on the determination that the idle indicator has been set, identifying a second cache line to be evicted from a second set of cache lines of the mid-level cache and sending a request to write the second cache line to the LLC. In an embodiment, the method further comprises setting the idle indicator when a request queue of the LLC remains empty for a predetermined number of cycles. In an embodiment, the method further comprises resetting the idle indicator when a read request is received at the LLC. In an embodiment, the method further comprises resetting the idle indicator when the number of write requests in a request queue of the LLC exceeds a predetermined threshold. In an embodiment, the method further comprises based on the determination that the idle indicator has been set, identifying a third cache line to be evicted from a third set of cache lines of the mid-level cache and determining not to send a request to write the third cache line to the LLC based on a determination that the LLC already includes the third cache line. In an embodiment, the method further comprises receiving a request for a cache line from the mid-level cache; and based on a determination that the request is a store request, deallocating the requested cache line from the LLC. In an embodiment, the method further comprises receiving a request for a cache line from the mid-level cache; and based on a determination that the request is a read request, preserving the cache line in the LLC without changing a replacement age of the cache line. In an embodiment, the method further comprises receiving a request for a cache line from a level one cache; and based on a determination that the request is a store request and the requested cache line is duplicated in the LLC, sending a hint to the LLC to deallocate the cache line. In an embodiment, the method further comprises based on a determination that a cache line is to be evicted from a set of cache lines of the mid-level cache, determining whether a number of frequently dirty cache lines of the set is below a predetermined threshold; and omitting the frequently dirty lines from eviction selection when the number of frequently dirty cache lines is below the predetermined threshold.

In at least one embodiment, a system comprises means for determining that an idle indicator has been set, wherein the idle indicator is set based on an amount of activity at the LLC; and means for, based on the determination that the idle indicator has been set, identifying a first cache line to be evicted from a first set of cache lines of the mid-level cache and sending a request to write the first cache line to the LLC.

In an embodiment, the system further comprises means for, based on the determination that the idle indicator has been set, identifying a second cache line to be evicted from a second set of cache lines of the mid-level cache and sending a request to write the second cache line to the LLC. In an embodiment, the system further comprises means for setting the idle indicator when a request queue of the LLC remains empty for a predetermined number of cycles. In an embodiment, the system further comprises means for resetting the idle indicator when a read request is received at the LLC. In an embodiment, the system further comprises means for resetting the idle indicator when the number of write requests in a request queue of the LLC exceeds a predetermined threshold.

In at least one embodiment, a non-transitory machine readable storage medium has instructions stored thereon, the instructions when executed by a machine to cause the machine to determine that an idle indicator has been set, wherein the idle indicator is set based on an amount of activity at a last level cache (LLC); and based on the determination that the idle indicator has been set, identify a first cache line to be evicted from a first set of cache lines of a mid-level cache and send a request to write the first cache line to the LLC.

In an embodiment, the instructions when executed further cause the machine to, based on the determination that the idle indicator has been set, identify a second cache line to be evicted from a second set of cache lines of the mid-level cache and send a request to write the second cache line to the LLC In an embodiment, the instructions when executed further cause the machine to set the idle indicator when a request queue of the LLC remains empty for a predetermined number of cycles. In an embodiment, the instructions when executed further cause the machine to reset the idle indicator when a read request is received at the LLC. In an embodiment, the instructions when executed further cause the machine to reset the idle indicator when the number of write requests in a request queue of the LLC exceeds a predetermined threshold.

In at least one embodiment, a system comprises a processing core; a main memory; a last level cache (LLC) to cache data stored in the main memory; and a mid-level cache to determine that an idle indicator has been set, wherein the idle indicator is set based on an amount of activity at the LLC; and based on a determination that the idle indicator has been set, identify a first cache line to be evicted from a first set of cache lines of the mid-level cache and send a request to write the first cache line to the LLC.

In an embodiment, the mid-level cache is to, based on the determination that the idle indicator has been set, identify a second cache line to be evicted from a second set of cache lines of the mid-level cache and send a request to write the second cache line to the LLC. In an embodiment, the system further comprises an L2 scrubber to set the idle indicator when a request queue of the LLC remains empty for a predetermined number of cycles. In an embodiment, the system further comprises an L2 scrubber to reset the idle indicator when a read request is received at the LLC. In an embodiment, the system further comprises an L2 scrubber to reset the idle indicator when the number of write requests in a request queue of the LLC exceeds a predetermined threshold.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A processor comprising:
a processing core;
a last level cache (LLC); and
a mid-level cache to:
determine that an idle indicator has been set, wherein the idle indicator is set based on an amount of activity at the LLC; and
based on a determination that the idle indicator has been set, identify a first cache line to be evicted from a first set of cache lines of the mid-level cache and send a request to write the first cache line to the LLC.

2. The processor of claim 1, wherein the mid-level cache is to:
based on the determination that the idle indicator has been set, identify a second cache line to be evicted from a second set of cache lines of the mid-level cache and send a request to write the second cache line to the LLC.

3. The processor of claim 1, further comprising an L2 scrubber to set the idle indicator when a request queue of the LLC remains empty for a predetermined number of cycles.

4. The processor of claim 1, further comprising an L2 scrubber to reset the idle indicator when a read request is received at the LLC.

5. The processor of claim 1, further comprising an L2 scrubber to reset the idle indicator when the number of write requests in a request queue of the LLC exceeds a predetermined threshold.

6. The processor of claim 1, wherein the mid-level cache is to:
based on the determination that the idle indicator has been set, identify a third cache line to be evicted from a third set of cache lines of the mid-level cache and determine not to send a request to write the third cache line to the LLC based on a determination that the LLC already includes the third cache line.

7. The processor of claim 1, wherein the LLC is to:
receive a request for a cache line from the mid-level cache; and
based on a determination that the request is a store request, deallocate the requested cache line from the LLC.

8. The processor of claim 1, wherein the LLC is to:
receive a request for a cache line from the mid-level cache; and
based on a determination that the request is a read request, preserve the cache line in the LLC without changing a replacement age of the cache line.

9. The processor of claim 1, wherein the mid-level cache is to:
receive a request for a cache line from a level one cache; and
based on a determination that the request is a store request and the requested cache line is duplicated in the LLC, send a hint to the LLC to deallocate the cache line.

10. The processor of claim 1, wherein the mid-level cache is to:
based on a determination that a cache line is to be evicted from a set of cache lines of the mid-level cache, determine whether a number of frequently dirty cache lines of the set is below a predetermined threshold; and
omit the frequently dirty lines from eviction selection when the number of frequently dirty cache lines is below the predetermined threshold.

11. A method comprising:
determining, by a mid-level cache, that an idle indicator has been set, wherein the idle indicator is set based on an amount of activity at a last level cache (LLC); and
based on the determination that the idle indicator has been set, identifying a first cache line to be evicted from a first set of cache lines of the mid-level cache and sending a request to write the first cache line to the LLC.

12. The method of claim 11, further comprising:
based on the determination that the idle indicator has been set, identifying a second cache line to be evicted from a second set of cache lines of the mid-level cache and sending a request to write the second cache line to the LLC.

13. The method of claim 11, further comprising setting the idle indicator when a request queue of the LLC remains empty for a predetermined number of cycles.

14. The method of claim 11, further comprising resetting the idle indicator when a read request is received at the LLC.

15. The method of claim 11, further comprising resetting the idle indicator when the number of write requests in a request queue of the LLC exceeds a predetermined threshold.

16. A non-transitory machine readable storage medium having instructions stored thereon, the instructions when executed by a machine to cause the machine to:
determine that an idle indicator has been set, wherein the idle indicator is set based on an amount of activity at a last level cache (LLC); and
based on the determination that the idle indicator has been set, identify a first cache line to be evicted from a first set of cache lines of a mid-level cache and send a request to write the first cache line to the LLC.

17. The storage medium of claim 16, the instructions when executed to further cause the machine to:
based on the determination that the idle indicator has been set, identify a second cache line to be evicted from a second set of cache lines of the mid-level cache and send a request to write the second cache line to the LLC.

18. The storage medium of claim 16, the instructions when executed to further cause the machine to set the idle indicator when a request queue of the LLC remains empty for a predetermined number of cycles.

19. The storage medium of claim 16, the instructions when executed to further cause the machine to reset the idle indicator when a read request is received at the LLC.

20. The storage medium of claim 16, the instructions when executed to further cause the machine to reset the idle indicator when the number of write requests in a request queue of the LLC exceeds a predetermined threshold.
